(19) United States
(12) Patent Application Publication
(10) Pub. No.: US 2007/0197239 A1
(43) Pub. Date: Aug. 23, 2007

(54) GLOBAL WIRELESS UNIFIED MESSAGING SYSTEM AND METHOD

(75) Inventor: Shirish Sane, Dayton, NJ (US)

Correspondence Address: TROUTMAN SANDERS LLP, 600 PEACHTREE STREET , NE, ATLANTA, GA, 30308, US

(73) Assignee: Global Wireless Unified Messaging Systems, LLC, New York, NY (US)

(21) Appl. No.: 11/676,690

(22) Filed: Feb. 20, 2007

Related U.S. Application Data
(60) Provisional application No. 60/774,963, filed on Feb. 17, 2006.

(51) Int. Cl. H04Q 7/20

(52) U.S. Cl. 455/466

(57) ABSTRACT

Disclosed herein is a method for providing global wireless unified messaging including receiving a registration of a wireless device corresponding to a user, associating a event with the user, receiving an alert relating to the event, and transmitting a event alert to the wireless device responsive to the alert.

### CROSS REFERENCE TO RELATED APPLICATION

This application claims priority of U.S. Provisional Patent Application No. 60/774,963 filed 17 Feb. 2006, the entire contents of which is hereby incorporated by reference.

### TECHNICAL FIELD

The present invention relates, generally, to a system for wireless messaging, and, more particularly, to a system and method for providing global wireless unified messaging.

### BACKGROUND OF THE INVENTION

Handheld computing devices continue to offer better products and the number of mobile devices continues to grow at an exponential rate. Some current projections have the number of wireless devices exceeding one billion users worldwide within the year. Currently, the mobile device industry is experiencing the convergence of technologies in the form of wireless PDA's with Bluetooth technology and cellular phones with PDA and email capabilities. Sun Microsystems has introduced a J2ME platform that lets mobile phones and PDAs run Java programs, W3C group is working on the CC/PP specification, which aims to provide an open, public way to describe any device's characteristics. The wireless networks have become faster and more reliable and satellite providers have launched more communications satellites and are offering new services such as Inmarsat Mobile ISDN, commonly referred to as GAN.

While technology firms are busy providing either more advanced equipment or faster and better wireless infrastructure, there is still a need for smart business applications for the multitude of devices using a multitude of wireless protocols worldwide. These business applications, if they have to provide a cost effective, efficient and productive set of tools, will have to consider the very nature of such mobile devices and the infrastructure they will use.

Additionally, as users continue to use a wide range of devices other users may not be aware of the type of device and therefore the type of messages to send to others. Furthermore, while users may have multiple devices, they may prefer to receive messages on a specific device or in a specific format. These preferences may not be known to other users and changes in the preferences may not be communicated to other users. Consequently, users of wireless messaging devices are not able to reliably receive wireless messages in their preferred format without the sender of the messaging having previous knowledge of their preferred message format.

As a result, a need exists for a system that enables a user to access and/or retrieve a variety of messages, including voice mail messages, facsimiles, and electronic mail messages via a global unified wireless messaging system that clearly is capable of delivering wireless messages in a wide variety of message formats. Additionally, what is needed is a unified wireless messaging system that can bring together all of the wireless and wired devices, manage configuration of processes and business critical information in the form of messages or alerts.

### BRIEF SUMMARY OF THE INVENTION

Generally described, the present invention comprises a system and methods for providing global unified wireless messaging. The global unified wireless messaging system is capable of delivering wireless messages to wireless device located throughout the world that may utilize a wide variety of wireless protocols. Additionally, the global unified wireless messaging system is capable of delivering the wireless messages in a wide variety of customized formats that can be specified by the user of the wireless device. The global unified wireless messaging system allows users to create and manage various events that make a process and deliver the event information across the entire workflow, either corporate or personal, in a cascaded manner while the user has complete control over the dissemination of such information.

The method for providing global wireless messaging includes receiving a registration of a wireless device corresponding to a user, associating an event or multiple simultaneous events with the user, receiving an alert relating to the event, and transmitting a event alert to the wireless device responsive to the alert. GWUM will remove the barrier and enable all devices, wired or unwired to receive and send (2-way Interactive Messaging) the intended data, at any place, any time, anywhere, any bandwidth scenario. The GWUM system can automatically deliver time-critical business intelligence to decision-makers through email and mobile alert notification technologies regardless of network or device.

Also disclosed herein is a global wireless messaging system including a user interface that allows a user to register a wireless devices associated with the user; a memory storage device that stores a user registration information; and a data processing unit for processing alerts that includes a alert receiving unit that receives an alert that corresponds to one or more events, a data filtering unit that correlates the alert to one or more users based on the users registration information, and a distribution unit that transmits an event alert to the wireless device associated with the user responsive to the alert.

Further disclosed herein is a computer program product for providing global wireless unified messaging, the computer program product including: a storage medium readable by a processing circuit and storing instructions for execution by the processing circuit for performing a method including receiving a registration of a wireless device corresponding to a user, associating a event with the user, receiving an alert relating to the event, and transmitting a event alert to the wireless device responsive to the alert.

Other features and advantages of the present invention will become apparent upon reading and understanding the present specification when taken in conjunction with the appended drawings.

### BRIEF DESCRIPTION OF THE FIGURES

FIG. 1 displays a block diagram representation of a system for providing global wireless unified messaging in accordance with exemplary embodiments of the present invention.

FIG. 2 displays a block diagram representation of a computing environment which may be utilized in accordance with exemplary embodiments of the present invention.

FIG. 3 displays a block diagram representation of a global wireless unified messaging server utilized to process received user registration information in accordance with exemplary embodiments of the present invention.

FIG. 4 displays a logic flow diagram representing a method of providing global wireless unified messaging in accordance with exemplary embodiments of the present invention.

FIG. 5 displays a block diagram representation of a global wireless unified messaging system in accordance with exemplary embodiments of the present invention.

The detailed description explains the preferred embodiments of the invention, together with advantages and features, by way of example with reference to the drawings.

### DETAILED DESCRIPTION OF THE INVENTION

Generally described, the present invention comprises a system and methods for providing global unified wireless messaging. The global unified wireless messaging system is capable of delivering wireless messages to wireless devices located throughout the world that may utilize a wide variety of wireless protocols. Additionally, the global unified wireless messaging system is capable of delivering the wireless messages in a wide variety of customized formats that can be specified by the user of the wireless device. The global unified wireless messaging system allows users to create and manage various events that make a process and deliver the event information across the entire workflow, either corporate or personal, in a cascaded manner while the user has complete control over the dissemination of such information. The global unified wireless messaging system is described herein with reference to exemplary embodiments, these exemplary embodiments are given for illustration only and are not considered to be limiting in anyway.

The global unified wireless messaging system described herein is a wireless messaging platform that can be used throughout the globe on various wireless protocols. The system is both modular and scalable, it receives and delivers user defined configured messages across various messaging protocols, including satellite based communications. The global unified wireless messaging system works with a suite of applications or modules that are transparent to the users and have a plug-and-play capability between each other. Theses applications are designed and implemented in multiple layers and provide the basic technology platform that is fully configurable. In one embodiment, the top layer consists of modules made up of enterprise connectors and integration API's targeted at various industry verticals.

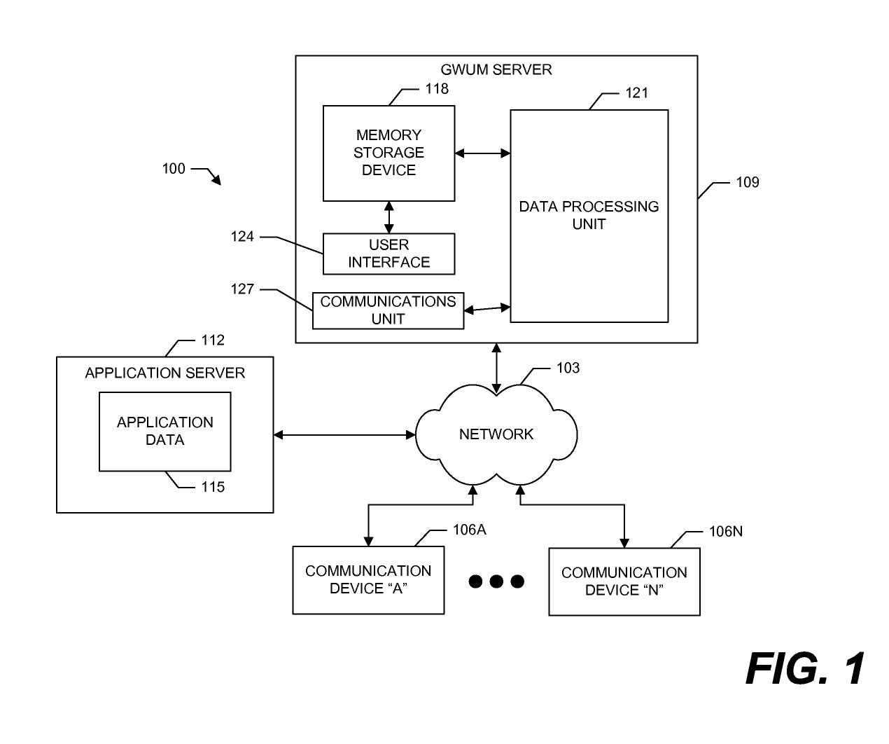

Referring now to the drawings, in which like numerals represent like components or steps throughout the several views, FIG. 1 displays a block diagram representation of a system 100 for providing global unified wireless messaging in accordance with exemplary embodiments of the present invention. Generally, the global wireless unified messaging “GWUM” system 100 comprises an GWUM server 109, an application server 112, and a number of wireless communication devices 106A-106N connected together via a communication network 103 (i.e., also referred to herein as a “network 103”). One skilled in the art will recognize that the network 103 typically contains the infrastructure and facilities appropriate to connect a group of two or more wireless communication devices 106A-106N (including, without limitation, a number of computer systems in communication with each other), along with the GWUM server 109 and application server 112.

The network 103, GWUM server 109, application server 112, and wireless communication devices 106A-106N can be configured in multiple network topologies including, but not limited to, star, bus, or ring configurations. Also, the network 103, GWUM server 109, application server 112, and wireless communication devices 106A-106N can be broadly categorized as belonging to a particular architecture including, but not limited to, peer-to-peer or client/server architectures. The network 103 can additionally be classified by the geographical location of the wireless communication devices 106A-106N and the types thereof. For example, if the network 103 connects a number of computer systems or servers located in relatively close proximity to each other, such as within a building, the network 103 is referred to as a local-area network (LAN). If the computer systems are located farther apart, the network 103 is generally referred to as a wide-area network (WAN), such as the Internet. If the computer systems are located within a limited geographical area, such as a university campus or military establishment, the network 103 is referred to as a campus-area network (CAN). Similarly, if the computer systems are connected together within a city or town, the network 103 is referred to as a metropolitan-area network (MAN). Finally, if the computer systems are connected together within a user's home, the network 103 is referred to as a home-area network (HAN).

Further the present invention can include a network 103 that does not rely on the client/server architecture. Accordingly, GWUM server 109 can include a client machine rather than a server, wherein communication between the wireless communication devices 106A-106N and the GWUM server 109 occurs over shared network drives.

The number of wireless communication devices 106A-106N within the GWUM system 100 can vary depending on the requirements of the GWUM system 100. In one embodiment of the present invention, the number of wireless communication devices 106A-106N corresponds to the number of users (e.g., departments or individuals) registered to receive event alerts from the GWUM system 100 via the GWUM server 109. For example and not limitation, the results generated by the GWUM system 100 can be provided to each registered user through the use of e-mail, voicemail, SMS, facsimile, or the like. Accordingly, each communication device 106A-106N may include a basic e-mail application, a voicemail application, a text message application, a facsimile application, or the like that allows the user to adequately access and receive the event alerts generated by the GWUM system 100, as described more fully below.

The GWUM server 109, application server 112, and each communication device 106A-106N connect to the network 103, through use of a network interface and other appropriate hardware and software components, for bi-directional communication of signals and data therewith and, therefore, connect communicatively to each other. In an exemplary embodiment of the present invention, the GWUM server 109 includes a memory storage device 118, a data processing unit 121, a user interface 124, and communications unit 127. While the GWUM server 109 can comprise all of the aforementioned components, one skilled in the art will recognize that the aforementioned components may reside on separate computer devices within a distributed system.

The memory storage device 118 is capable of storing and retrieving data and is in communication with the data processing unit 121 and the user interface 124, such that the data can be provided to and received from the data processing unit 121 and the user interface 124. The memory storage device 118 can include, but is not limited to, volatile and/or non-volatile memory, or a combination thereof.

The data processing unit 121 is configured with hardware and/or software appropriate to perform tasks and provide capabilities and functionality as described herein. The data processing unit 121 communicates with the memory storage device 118 for data processing and the communications unit 127 for data distribution. Initially, the data processing unit 121 processes the application data 115 received from the application server 112, such that each event or workflow the application data 115 is stored in a separate file within the memory storage device 118. The data processing unit 121 further filters the alerts for relevant records or messages that correspond to user provided registration information. Additionally, the data processing unit 121 is capable of distributing the matching results discovered during the filtering process to the corresponding user, such as by e-mail via the communications unit 127.

The communications unit 127 is adapted to send e-mails, text messages, voicemails, facsimile, or the like generated by the data processing unit 121 to the corresponding users. For example and not limitation, the communications unit 127 may provide a message, or event alert, containing results from the data processing unit 121 to the corresponding communication device 106A-106N associated with the registered user. One skilled in the art will recognize, however, that results generated by the data processing unit 121 can be provided to registered users via other communication mediums such as, but not limited to, web-based reports, facsimile, voicemail, or printed documents.

The user interface 124 is adapted to receive registration and event data from a user (such as through a communication device 106A-106N) and provide the received data to the memory storage device 118 for storage. For example and not limitation, the user can provide desired registration information, which are associated with the particular user, to be subsequently used by the data processing unit 121. One skilled in the art will recognize that the user interface 124 may be designed in a variety of embodiments and formats and may range from a simple to a more complex configuration. Further, the user interface 124 can be configured so that each registered user of the GWUM system 100 is capable of modifying, adding, and/or deleting registration information stored on the memory storage device 118, or can be configured so that only a designated administrator (with appropriate security privileges) is capable of modifying, adding, and/or deleting registration information for a particular user.

The GWUM system 100 receives registration information from a user that includes information about a wireless communications device associated with the user. The registration information also includes information about the event alerts that the user wishes to receive and the format of the event alerts. The application server 112 may generate one or more alerts based on various application data 115. After the application server 112 generates the alert, the alert is transmitted to the GWUM server 109 via the network 103. The data processing unit 121 compares the received alert to the registration information received from the users. The data processing 121 generates one or more event alerts which are transmitted to the corresponding wireless communications device.

One skilled in the art will recognize that elements of the GWUM system 100, discussed above, can be connected through any appropriate communication channels that allow for bi-directional communication of signals and/or data. Such communication channels include, but are not limited to, analog, digital, wired and wireless communication channels. The communication channels may be copper wire, optical fiber, radio frequency (RF), infrared, satellite, and the like.

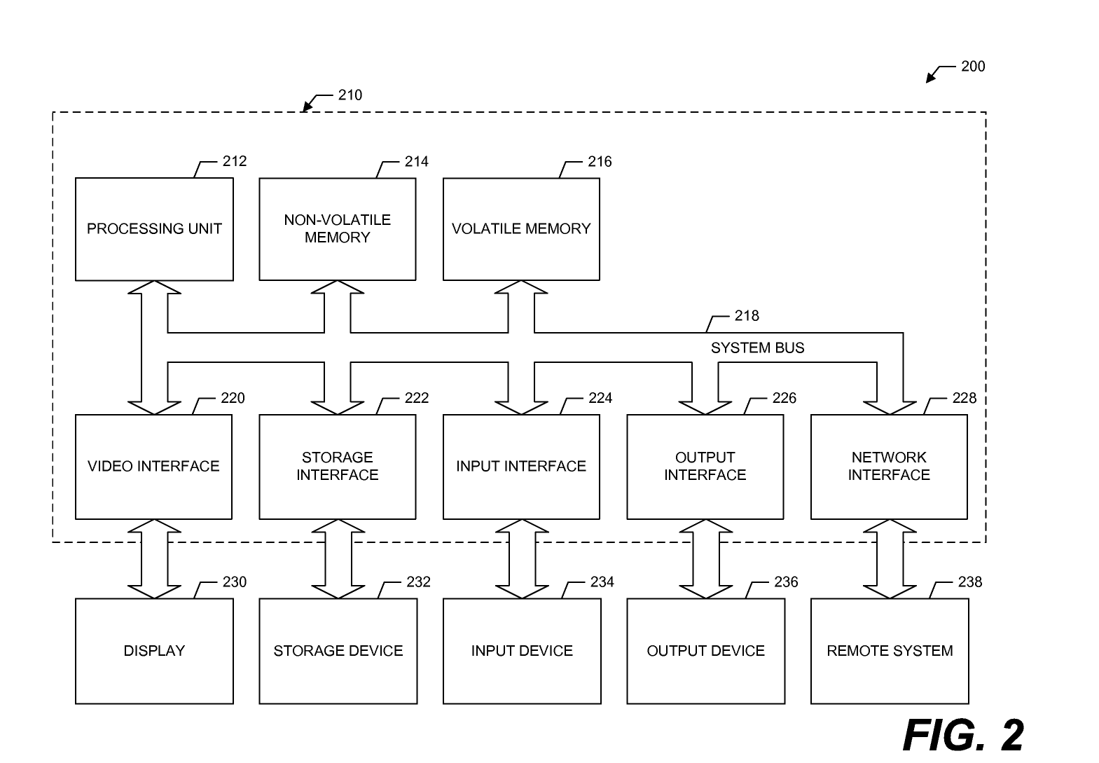

FIG. 2 displays a block diagram representation of a computing environment 200 which may be utilized in accordance with exemplary embodiments of the GWUM system 100 of the present invention. More particularly, wireless communication devices 106A-106N, GWUM server 109, and application server 112 can use the computing environment 200 described herein. Wireless communication devices 106A-106N, GWUM server 109, and application server 112 of the GWUM system 100 can include, but are not limited to, personal computers, mainframe computers, servers, hand-held or laptop devices, multiprocessor systems, microprocessor-based systems, set-top boxes, programmable consumer electronics, network PCs, minicomputers, distributed computing environments that include any of the above systems or devices, and the like. It should be understood, however, that the features and aspects of the GWUM system 100 can be implemented by or into a variety of systems and system configurations and any examples provided within this description are for illustrative purposes only.

FIG. 2 and the following discussion provide a general overview of a platform onto which an embodiment of the present invention, or portions thereof, can be integrated, implemented and/or executed. Although reference has been made to instructions within a software program being executed by a processing unit, those skilled in the art will understand that at least some of the functions performed by the software can also be implemented by using hardware components, state machines, or a combination of any of these techniques. In addition, a software program which may implement an embodiment of the present invention can also run as a stand-alone program or as a software module, routine, or function call, operating in conjunction with an operating system, another program, system call, interrupt routine, library routine, or the like. The term program module is used herein to refer to software programs, routines, functions, macros, data, data structures, or any set of machine readable instructions or object code, or software instructions that can be compiled into such, and executed by a processing unit 212.

Turning now to the figure, computing device 210 may comprise various components including, but not limited to, a processing unit 212, a non-volatile memory 214, a volatile memory 216, and a system bus 218. The non-volatile memory 214 can include a variety of memory types including, but not limited to, read only memory (ROM), electronically erasable read only memory (EEROM), electronically erasable and programmable read only memory (EEPROM), electronically programmable read only memory (EPROM), electronically alterable read only memory (EAROM), FLASH memory, bubble memory, battery backed random access memory (RAM), compact disc read only memory (CDROM), digital versatile disc (DVD), or other optical disk storage, magnetic cassettes, magnetic tape, magneto-optical storage devices, magnetic disk storage or other magnetic storage devices, or any other medium which may be used to store the desired information. The non-volatile memory 214 can provide storage for power-on and reset routines (bootstrap routines) that are invoked upon applying power or resetting the computing device 210. In some configurations the non-volatile memory 214 can provide the basic input/output system (BIOS) routines that are utilized to perform the transfer of information between elements within the various components of the computing device 210.

The volatile memory 216 can include a variety of memory types and devices including, but not limited to, random access memory (RAM), dynamic random access memory (DRAM), synchronous dynamic random access memory (SDRAM), double data rate synchronous dynamic random access memory (DDR-SDRAM), bubble memory, registers, or the like. The volatile memory 216 can provide temporary storage for routines, modules, functions, macros, data, etc. that are being or may be executed by, or are being accessed or modified by, the processing unit 212.

Alternatively, the non-volatile memory 214 and/or the volatile memory 216 can be a remote storage facility accessible through a distributed network system. Additionally, the non-volatile memory 214 and/or the volatile memory 216 can be a memory system comprising a multi-stage system of primary and secondary memory devices, as described above. The primary memory device and secondary memory device can operate as a cache for each other or the second memory device can serve as a backup to the primary memory device. In yet another embodiment, the non-volatile memory 214 and/or the volatile memory 216 can comprise a memory device configured as a simple database file or as a searchable, relational database using a query language, such as SQL.

The computing device 210 can access one or more external display devices 230 such as a CRT monitor, LCD panel, LED panel, electro-luminescent panel, or other display device, for the purpose of providing information or computing results to a user. In some embodiments, the external display device 230 can actually be incorporated into the product itself. For example, the computing device 210 can be a mobile device having a display device 230. The processing unit 212 can interface to each display device 230 through a video interface 220 coupled to the processing unit 210 over the system bus 218.

In operation, the computing device 210 sends output information to the display 230 and to one or more output devices 236 such as a speaker, modem, printer, plotter, facsimile machine, RF or infrared transmitter, computer or any other of a variety of devices that may be controlled by the computing device 210. The processing unit 212 can interface to each output device 236 through an output interface 226 coupled to the processing unit 212 over the system bus 218.

The computing device 210 can receive input or commands from one or more input devices 234 such as, but not limited to, a keyboard, pointing device, mouse, modem, RF or infrared receiver, microphone, joystick, track ball, light pen, game pad, scanner, camera, computer or the like. The processing unit 212 may interface to each input device 234 through an input interface 224 coupled to the processing unit 212 over the system bus 218.

It will be appreciated that program modules implementing various embodiments of the present invention can be stored in the non-volatile memory 214, the volatile memory 216, or in a remote memory storage device accessible through the output interface 226 and the input interface 224. The program modules can include an operating system, application programs, other program modules, and program data. The processing unit 212 can access various portions of the program modules in response to the various instructions contained therein, as well as under the direction of events occurring or being received over the input interface 224.

The computing device 210 can provide data to and receive data from one or more other storage devices 232, which can provide volatile or non-volatile memory for storage and which can be accessed by computing device 210. The processing unit 212 can interface to each storage device 232 through a storage interface 222 over the system bus 218.

The interfaces 220, 222, 224, 226, and 228 can include one or more of a variety of interfaces, including but not limited to, cable modems, DSL, T1, T3, optical carrier (e.g., OC-3), V-series modems, an RS-232 serial port interface or other serial port interface, a parallel port interface, a universal serial bus (USB), a general purpose interface bus (GPIB), an optical interface such as infrared or IrDA, an RF or wireless interface such as Bluetooth, and the like.

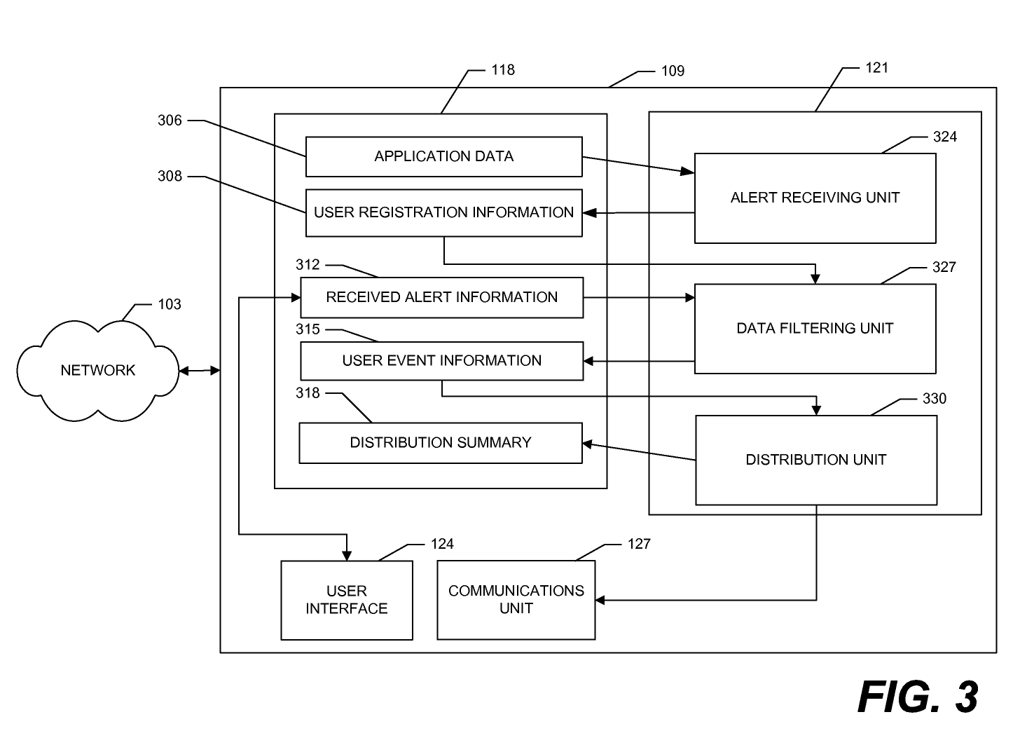

Turning now to FIG. 3 a block diagram representation of a global wireless unified messaging server 109 utilized to process received user registration information in accordance with exemplary embodiments of the present invention. The GWUM server 109 includes the data processing unit 121 which is comprised of an alert receiving unit 324, a data filtering unit 327 and a distribution unit 330. The alert receiving unit 324 is operable to receive alerts from both end users via wireless communication devices or from the application server 112. The data filtering unit 327 compares the received alert information 312 to the user registration information 308 and generates user event information 315 that includes event alerts that need to be distributed to each user. The user event information is then sent to the distribution unit 330, which creates the event alert for each user in the format the user specified in the user registration information 308 and transmits the event alert to the communications unit 127 so that it may be communicated to the user's wireless communication device.

The GWUM server 109 also includes a user interface 124 that can be used to enter user registration information into the GWUM server 109. In one embodiment, the user interface 124 may be a website that allows users to provide their registration information including, but not limited to, events that they wish to be provided alerts on, the method of alerts they would like to receive, the format of the alerts that they wish to receive, and the wireless device they want the alerts sent to. The registration information may include much more information than the format that the user would like to receive event alerts in. For example, the registration information may include the manufacture and model of the wireless device, personal information about the user, and information about events of interest to the user.

In another exemplary embodiment, the GWUM server 109 may maintain a distribution summary 318, which is a log of the event alerts transmitted, the format of the event alerts, the destination of the event alerts, and if a delivery acknowledgement was received for the event alert.

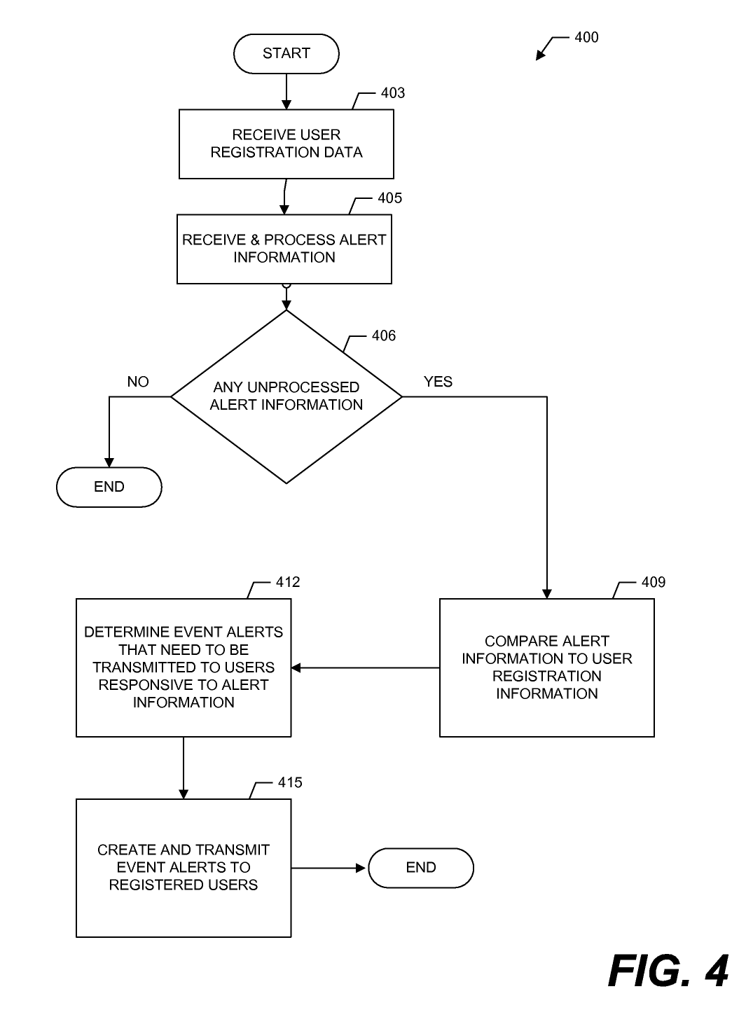

Referring now to FIG. 4, a logic flow diagram representing a method 400 of providing global wireless unified messaging in accordance with exemplary embodiments of the present invention. The method 400 starts at method step 403 where the GWUM server receives the registration information corresponding to a user. After receiving the user registration information, the method 400 receives and processes alert information as shown at method step 405. The alert information may be received from a variety of sources including, but not limited too, from a user via a wireless device, from the application server, or from a user via the user interface 124. Once alert information has been received, the method 400 compares the alert information to the user registration information, as shown at method step 409. At method step, 412, the method 400 determines what registered users should receive event alerts responsive to the alert information. Finally, at method step 415 the method 400 includes creating the desired event alerts and transmitting them to the registered users in accordance with the user's registration information.

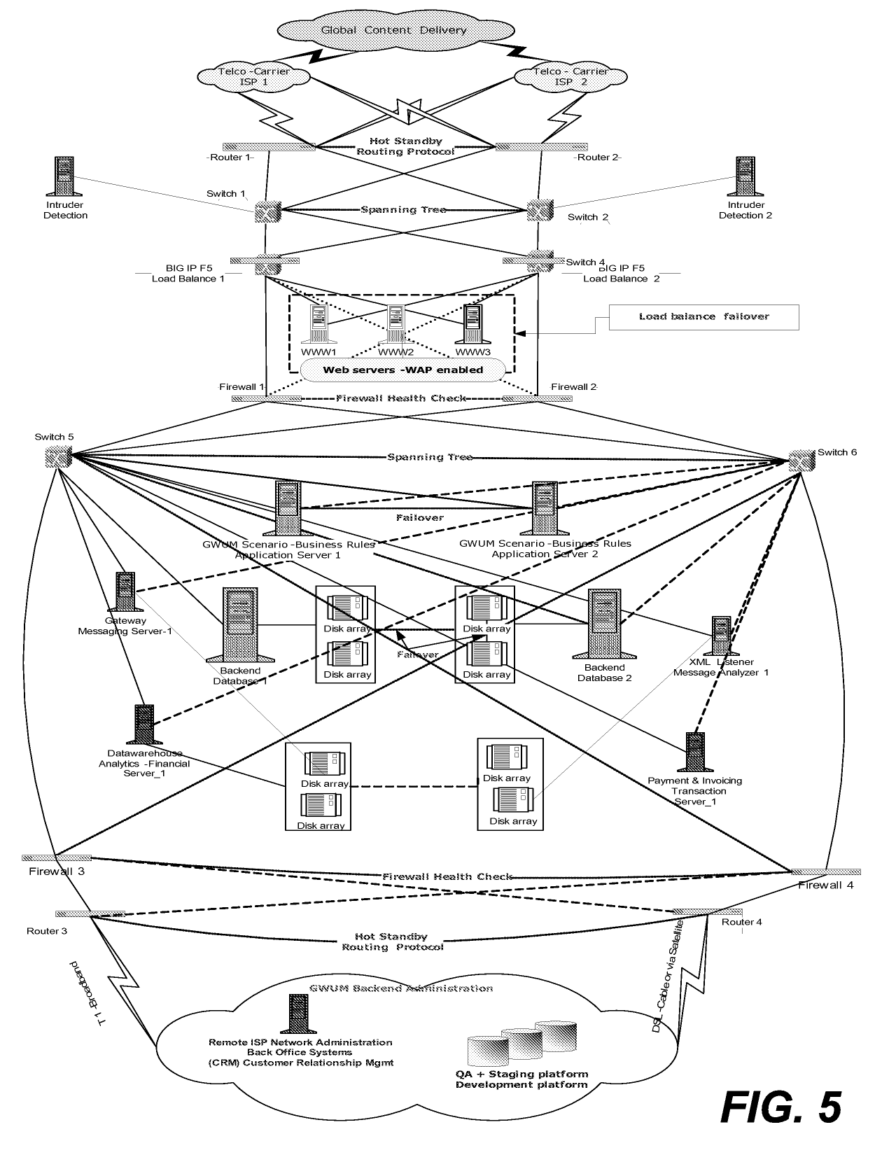

Referring now to FIG. 5, a block diagram of an exemplary embodiment of a GWUM system is shown. The GWUM system illustrated in FIG. 5 includes a plurality of routers, switches, gateways, servers, data warehouses, and disk arrays. The specific system architecture illustrated in FIG. 5 is shown for exemplary purposes only and is not intended to be limiting in any way.

In an exemplary embodiment, The GWUM system 100 includes of a suite of applications that are transparent to the users and have a plug-and-play capability between each other. The applications may be designed in multiple layers and provide a basic technology platform that is fully configurable. The end layer consists of applications that may be targeted at various vertical industries such as travel, concierge, logistics, supply chain, office suites, and the like. The GWUM system 100 can use currently available wireless technology for its message transfers and it may also use currently available technology for wireless devices for text message transfers. In general, the GWUM system 100 uses a ‘Deliver Anywhere’ approach and works seamlessly between different messaging protocols including, but not limited to, CDMA, GSM, GPRS and the like. In addition, the GWUM system 100 is designed to work with satellite/cellular phones using their underlying protocols and PDA's using operating systems including, but not limited to, Microsoft Windows CE, Pocket PC, Palm OS, and the like. The GWUM system 100 intelligently routes messages via SMTP, Text/SMS, Satellite, GSM/GPRS, CDMA etc. depending upon the receiving device configured.

The GWUM system reduce costs and increase workforce efficiency and productivity in many ways, including, but not limited to, providing real-time event alerts to on-the-road sales force about critical activities for their clients and prospects, notifying a mobile service technician about client emergencies or delays to needed parts, enabling business employees to use their cellular, satellite phones or PDAs to keep updated about changes and modifications in their various schedules and activities, and enabling business executives to continue to receive key business reports even when they're on the road, on the plane, or at air or at sea.

The GWUM system 100 will now be discussed with reference to several exemplary implementations that are provided solely by way of example and not for limitation.

One example of an application that can be implemented with the GWUM system is that of a Travel system. For example, when a traveler books a trip, which includes a flight, a car service, and a hotel, the user will provide registration information that is communicated to the GWUM system relating to the trip. In this case, the user registration information may include, but is not limited to, flight information, car service information, and hotel information as well as information about how the user would like to be notified of events that may affect his trip. For example, the user may have a BlackBerry and desire to receive an email alerting him to changes that may affect his trip. In another example, the user may only have a cell phone and wish to receive SMS messages or voicemails notifying him of changes in his trip. Additionally, the user may directly or indirectly provide the GWUM system with information about third parties to provide cascaded alerts regarding the user's trip. The user may wish for the car service to be automatically notified of any delay in the user's arrival or any change in the arrival location of the user, with or without the notification of the user. In one example, if a user's plan id delayed in flight the user may want the GWUM system to automatically notify the car service that the user will be arriving late. Furthermore, the user may specify that the user would like alerts sent to other individuals that will be affected by the delay of the user.

The GWUM system can be set up to automatically generate and transmit a series of cascaded event alerts to a plurality of individuals that are affected by an alert. For example, in the delay of a meeting several other uses may have relating delays in their other meetings. The GWUM system allows users to specify a hierarchy of events that can be used when determining a user's response to an event alert. For example, a user may have a meeting that they can not reschedule or that is more important than other meetings and the user may desire to respond to a event alert letting other attendees of a delayed meeting know that the user will not be able to attend due to the delay.

Another exemplary application of the GWUM system is that of an office calendaring system, similar to Microsoft's Outlook. For example, a user may provide registration information including the format and method that the user would prefer to receive event alerts in and may also allow the GWUM system to receive data directly from the calendaring system. The GWUM system receives alerts regarding changes in meetings such a time, attendees, or location from the calendaring system or from the wireless device of any of the users of the GWUM system. Upon receiving an alert relating to a meeting the GWUM system notifies all attendees of the meeting of the change in the meeting. Additionally, the GWUM system determines what additional events will be affected by the change in the meeting and notifies the corresponding parties of such changes. For example, a registered user of the GWUM system may have a 1 pm meeting with other attendees that are registered users of the GWUM system. One of the users scheduled to be in attendance for the meeting is running late for the meeting and needs to delay the start of the meeting by fifteen minutes, the user sends an alert to the GWUM system which processes the alert and sends event alerts to the other attendees notifying them of the delay. Furthermore, the GWUM system can use the application data received from the calendaring system to generate further cascaded event alerts. For example, if one of the other attendees of a meeting had a conference call scheduled to start at 2 pm the GWUM system may automatically reschedule the call to 2:15 and notify the other participants of the conference call of the change. In another exemplary embodiment, the calendaring system may be integrated with a hoteling, or room scheduling software application, that can be used to schedule conference rooms for meetings. Continuing with the above example, the GWUM system may automatically re-locate the meeting to a different location based upon changes in the meeting time and number of attendees scheduled to be at the meeting.

The event alerts in the calendaring system may be transmitted to the users in any manner in which the user specified when registering with the GWUM system. In addition, the user may appoint delegates that are able to enter alerts or receive event alerts on his behalf. For example, a user may wish to enable his or her secretary to make changes to his schedule. The registered users may also provide information on how they would like their delegates to receive event alerts regarding events for the user.

In another example the GWUM system can be used for business condition monitoring. For example, a plant or process may be monitored by a combination of hardware and software to ensure that a process operate as expected. If a process parameter exceeds a threshold value an alert may be generated. The GWUM system may receive this alert and generate one or more event alerts to notify various individual of the change of the process parameter. For instance, a manufacturing plant may have a desired output or quality rate that is monitored by a combination of hardware and software. The plant manager and other individuals may wish to be automatically and quickly notified of a decrease in the plant output or quality on their wireless devices. The GWUM system can receive the alerts and generate one or more event alerts to registered users in the format that they desire, i.e., voicemail, email, SMS, or the like. In exemplary embodiment, the GWUM system can include a workflow engine designed to be selectively message-enabled across multiple workflows for one or more of different properties for different locations and the user may send and/or receive wireless event alerts using the GWUM to track any changes to these properties or locations. The GWUM system may also generate logs and reports for such changes and message senders and/or recipients.

Yet another exemplary use of the GWUM system is in the area of advertising. The GWUM system is designed to deliver text, voice and video messages to wireless devices. GWUM goes across different protocols including SMTP in order to achieve this task. These alerts can be pre-defined and can be sent to a set of devices across a work flow simultaneously as a result of one or many condition(s) being met in a particular business environment. GWUM's 2-way messaging capability will enable the users to respond back to any of these messages they receive. The GWUM system can be customized to deliver the message or content to devices other than wireless phones, PDA's etc, such as digital signs providing a unique ability for digital content providers to automate the content delivery based upon certain pre-defined conditions to certain pre-defined devices capable of receiving such content. The conditions based upon which such content delivery is to take place are fully configurable by the content providers.

Video content can be provided either in a download-and-play mode or streaming media mode. Such a scenario typically may work out as follows. First, system users are configured onto the GWUM system. Next, the digital signs are configured onto the GWUM system as devices. Content delivery conditions are then configured onto GWUM system and digital content configured onto GWUM system. The content delivery condition may be triggered by GWUM causes the trigger, an external system causes the trigger, or an operator causes the trigger manually using the GWUM portal either via a desktop or a browser capable mobile device. GWUM then delivers the content to an external system for all the signs configured to finally display it on the signs. Finally, GWUM also alerts, if configured to do so, the ‘Audit’ or any such users as required that the content was delivered to the desirable destination or just logs it.

If a digital sign is capable of and can run some application agent say, a Java VM, it will be possible for the sign to communicate back to the GWUM system. This could even be a condition trigger as mentioned above. This would mean that a sign can potentially ‘ask’ for content or trigger content delivery to other signs. When a sign displays its intended content, the content can be used to direct a viewer to opt-in for different promotions/subscriptions/services etc. as relevant to the advertiser. A GWUM Enabled′ system to handle such opt-ins can utilize its 2-way messaging capability to receive opt-ins and send responses back to the customer. For example, a sign displays a message prompting viewers to opt-in to the desired service. Users can opt-in in multiple ways including, but not limited to, going to a given URL for the relevant GWUM portal in their web browser, send a text message to a pre-defined GWUM service, or if the sign is Bluetooth enabled, use their Bluetooth device to establish communication and credentials with the sign. The GWUM system will then send a pre-defined message to the opt-in customer on the mobile device they opted-in with. If the customer opts in with an email address, the GWUM system will send the message to that email address.

GWUM platform offers the capability of handling video messages either as static images or as Video clips. It can send these messages to a wide variety of available mobile devices that are capable of handling such a message. It is important to understand that for any message to be delivered to a destination, the destination must be known, in other words, credentials of a device will have to pre-establish before such a message can be sent. For example, a mobile device user identifies his/her mobile device to the GWUM system. In most cases, the user will also identify the kind of message to be delivered, say a coupon as an example of a static image. The GWUM system then sends this video to the device. Alternatively, the business logic to decide which video images are to be sent to the user, can be configured into the GWUM system which will then decide the video to be pushed to the configured device.

Whereas the present invention has been described in detail it is understood that variations and modifications can be effected within the spirit and scope of the invention, as described herein before and as defined in the appended claims. The corresponding structures, materials, acts, and equivalents of all mean-plus-function elements, if any, in the claims below are intended to include any structure, material, or acts for performing the functions in combination with other claimed elements as specifically claimed.

What is claimed is:

1. A method for providing global wireless unified messaging comprising:
receiving a registration of a wireless device corresponding to a user;
receiving a request from a user to create an event and associate the event with the user;
receiving an alert relating to the event; and
transmitting a event alert to the wireless device responsive to the alert.

2. The method of claim 1, wherein the registration includes a preferred format of the event alert.

3. The method of claim 1, further comprising generating alerts relating to one or more subsequent events associated with the user and transmitting a cascaded event alert to one or more additional users associated with the subsequent events.

4. The method of claim 1, further comprising receiving an acknowledgement that the event alert was successfully transmitted to the wireless device.

5. The method of claim 1, further comprising:
receiving a second registration of a second wireless device corresponding to a second user; and
associating the second user with the event;
wherein the alert relating to the event is received from the second wireless device.

6. The method of claim 1, wherein the alert is an automatically generated alert relating to the event.

7. The method of claim 4, wherein the event is a first meeting, the alert is a delay notice, the subsequent events are meetings scheduled after the first meeting that the user is scheduled to attend, and the cascaded event alerts are notices of delays corresponding to subsequently scheduled meetings.

8. A global wireless unified messaging system comprising:
a user interface that allows a user to register a wireless devices associated with the user;
a memory storage device that stores a user registration information; and
a data processing unit for processing alerts comprising:
a alert receiving unit that receives an alert that corresponds to one or more events;
a data filtering unit that correlates the alert to one or more users based on the users registration information; and
a distribution unit that transmits an event alert to the wireless device associated with the user responsive to the alert.

9. The global wireless unified messaging system of claim 8, wherein the user registration information includes a preferred format of the event alert.

10. The global wireless unified messaging system of claim 8, wherein the user register information is received from the user and includes the events that are of interest to the user.

11. The global wireless unified messaging system of claim 8, wherein the distribution unit is capable of transmitting the event alert in multiple wireless formats.

12. The global wireless unified messaging system of claim 8, wherein the distribution unit transmits the event alert to a second wireless device associated with a second user responsive to the alert.

13. The global wireless unified messaging system of claim 8, wherein the alert is automatically generated and received by the alert receiving unit.

14. The global wireless unified messaging system of claim 8, wherein the data filtering unit creates one or more cascaded event alerts responsive to the alert.

15. A computer program product for providing global wireless unified messaging, the computer program product comprising: a storage medium readable by a processing circuit and storing instructions for execution by the processing circuit for performing a method comprising:
receiving a registration of a wireless device corresponding to a user;
receiving a request from a user to create an event and associate the event with the user;
receiving an alert relating to the event; and
transmitting a event alert to the wireless device responsive to the alert.

16. The computer program product of claim 15, wherein the registration includes a preferred format of the event alert.

17. The computer program product of claim 15, further comprising generating alerts relating to one or more subsequent events associated with the user and transmitting a cascaded event alert to one or more additional users associated with the subsequent events.

18. The computer program product of claim 15, further comprising receiving an acknowledgement that the event alert was successfully transmitted to the wireless device.

19. The computer program product of claim 15, further comprising:
receiving a second registration of a second wireless device corresponding to a second user; and
associating the second user with the event;
wherein the alert relating to the event is received from the second wireless device.

20. The computer program product of claim 15, wherein the alert is an automatically generated alert relating to the event.
